(19) United States
(12) Patent Application Publication
(10) Pub. No.: US 2009/0321340 A1
(43) Pub. Date: Dec. 31, 2009

(54) FILTER CARTRIDGE FOR USE WITH A FILTER HEAD ASSEMBLY

(75) Inventors: Edmond Rampen, Oakville (CA); Scott MacDonald, Toronto (CA)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Envirogard Products Limited

(21) Appl. No.: 12/145,964

(22) Filed: Jun. 25, 2008

(51) Int. Cl. B01D 35/157; B01D 35/153

(52) U.S. Cl. 210/233; 210/235

(57) ABSTRACT

A filter cartridge for use with a filter head assembly and for filtering a stream of pressurized fluid. The filter cartridge comprises a housing enclosing filtering media, a retainer to releasably engage a receiver in a filter head assembly, and one or more rotationally engagable locks securing the filter cartridge to the filter head assembly upon the rotational engagement of the filter cartridge with the filter head assembly. The housing includes an upper end having therein entry and exit passages to permit fluid to enter the housing, pass through the filtering media and exit the housing. Rotational engagement of the filter cartridge with the filter head assembly causes the retainer and said the receiver to releasably secure the filter cartridge to the filter head assembly and to thereby permit fluid to travel from the filter head assembly through the entry passage and to permit fluid to pass from the exit passage into the filter head assembly. The locks help to resist the rotational disengagement of the filter cartridge from the filter head assembly.

### FIELD OF THE INVENTION

The present invention relates generally to filter cartridges of the type that may be used to filter a stream of pressurized fluid, and more specifically to an improved filter cartridge for use with a filter head assembly. In one embodiment the filter cartridge has enhanced leak prevention qualities while in other embodiments the filter cartridge includes means to control flow therethrough, and a reduced, potential for contamination.

### BACKGROUND OF THE INVENTION

Filter cartridges, and in particular replaceable filter cartridges for use in combination with a filter head assembly that operates to transport fluid to and from the filter, are commonly used in a wide variety of different applications. One such application that is becoming increasingly common is the use of replaceable filter cartridges and filter head assemblies to filter sources of household, industrial or commercial water. The head assemblies of these filtration units usually include some form of manifold that assists in directing unfiltered water or fluid through internal passages into an attached filter cartridge where contaminants, can be removed with cleaned and filtered water or fluid then being discharged through a separate and dedicated outlet port.

With the quality of large portions the world's drinking water coming into question, the filtration of residential and commercial water sources has become increasing more prevalent. Whereas only a few years ago residential or household water filters were relatively uncommon and most often limited to use in rural areas where ground water contamination was more common, today many homes and businesses in suburban areas that access municipal water sources utilize water filters. A wide variety of different filtering systems and filter cartridges have been developed to remove different types of contaminates (whether they be solid material, dissolved compounds, bacterial contaminants, viral contaminants, etc.). Generally such filtering systems have been developed to be as “user friendly” as possible, and utilize replaceable filter cartridges that can be easily replaced by a consumer or home owner. While to a large extent the filter cartridges that are currently available have been a success, unfortunately they are not without their limitations.

Typically, municipal and private water systems operate within a pressure range of from about 25 to about 125 psi. In order to comply with safety factors established by licensing and regulatory bodies, water filters for general or household use must in many instances be capable of withstanding or containing pressures of 500 psi (or more) without rupturing or failing. Regulatory approval typically requires the filters to withstand elevated pressures for a pre-determined length of time. As a result, manufacturers commonly conduct tests that slowly build up pressure within the water filter, maintain the pressure at the desired level for the required length of time, and then relieve the pressure after the test has been completed. Unfortunately, such testing is not in every case indicative of the environment within which the filters will be required to operate in residential and commercial settings.

In most Instances a water filter will be part of a water delivery system that will include a number of different appliances and numerous manual and/or automatic valves. For example, in a typical residential situation the water filter will usually be attached to the household water system that includes valves in bathrooms, kitchens, laundry rooms, etc. The opening and subsequent closing of each valve presents the possibility of creating water hammer, an event that can subject individual components of the system to extreme levels of pressure and stress on account of the shock wave that is developed and that travels through piping upon the closing of a valve. The incidence of water hammer is even greater for situations where electric solenoids are used (for example in automatic dishwashers and washing machines) on account of the speed at which solenoid valves close.

The effects of water hammer can range from a minor irritant in the form of rattling and noisy pipes, to significant damage or rupturing of pipes, fittings or other components of a water system. Where a typical filter cartridge and head assembly is part of that water system, water hammer can have a deleterious effect upon the components of that assembly, to the point where failure or leakage may occur. In that regard it has been found that water hammer has a tendency to unthread a threaded replaceable filter cartridge received within a filter head assembly. In such cases even a slight unthreading of the cartridge can result in leakage, or potentially a mixing of a filtered and unfiltered liquids, resulting in contamination issues. In a residential setting a leaking filter can often cause significant damage and inconvenience.

Commonly available filter cartridges also suffer from potential contamination prior to use. Filter cartridges that are currently in use typically contain an outlet port or spigot on their upper surface that is received within a correspondingly configured recess within the bottom of a filter head assembly. An inlet port or hole is provided at some location on the upper surface of the cartridge such that when the cartridge is received within the filter head unfiltered water can enter the cartridge through the inlet port, move through the filtering media, and eventually out through the outlet port into the treated water manifold within the filter head assembly. Although when secured within the filter head assembly such products provide a means to prevent contaminates that are outside of the stream of fluid being filtered from entering the cartridge, they do little to do so when sitting on a retailer's shelf. Commonly, filter cartridges are stored loosely on retail shelves or are merely packaged within cardboard or paper boxes or sleeves. Dirt, insects, and other sources of contamination can come into contact with either the inlet and/or outlet ports, or the filtering-media itself.

In order to help reduce potential contamination of water filters, and to present consumers with a simplified method of changing dirty filters, others have more recently began to produce enclosed canister filters wherein the filter media is completely enclosed within a canister-type vessel that is threadably or otherwise secured to a filter head assembly. When such filters need to be replaced, the entire canister is merely removed from the filter head and replaced with a new one, without the need to handle the filtering surfaces of the cartridge. Although such enclosed canister filters help to eliminate physical contact with the filter media and simplify the changing of filters, they provide manufacturers with little means to modify flow. In the case of older style filters having an exterior housing with a replaceable filter cartridge or core, flow control could be achieved through merely altering the design of the filter cartridge Itself or with external valves or flow control mechanisms. In the case of the newer styled enclosed canister filters, altering flow control often requires the modification of the inlet and, outlet ports of the canister and the filter head assembly which can often add considerably to manufacturing costs, and which can also require the replacement of filter head assemblies in the field.

### SUMMARY OF THE INVENTION

The invention therefore provides a filter cartridge for use with a filter head assembly that addresses some of the deficiencies of current products that are available in the marketplace. In these regards, in one embodiment the invention presents a mechanism to help prevent the disengagement or unthreading of a filter cartridge from a filter head assembly due to the effects of water hammer or varying Water pressure. In a further embodiment the invention presents a means to reduce the likelihood of contamination of the cartridge prior to its use. In a third embodiment the invention provides a simplified mechanism for controlling the flow of fluid through a filter cartridge.

Accordingly, in one of its aspects the invention provides a filter cartridge for use with a filter head assembly and for filtering a stream of pressurized fluid, the filter cartridge comprising, (i) a housing enclosing filtering media, said housing including an upper end having therein entry and exit passages to permit fluid to enter said housing, pass through said filtering media, and exit said housing; (ii) a retainer to releasably engage a receiver in a filter head assembly such that rotational engagement of said filter cartridge with the filter head assembly causes said retainer and said the receiver to releasably secure said filter cartridge to the filter head assembly and to thereby permit fluid to travel from the filter head assembly through said entry passage and to permit fluid to pass from said exit passage into the filter head assembly; and, (iii) one or more rotationally engagable locks securing said filter cartridge to the filter head assembly upon the rotational engagement of said filter cartridge with the filter head assembly, said locks helping to resist the rotational disengagement of said filter cartridge from the filter head assembly.

In another aspect the invention provides a filter cartridge for use with a filter head assembly and for filtering a stream of pressurized fluid, the filter cartridge comprising (i) a housing enclosing a filtering media, said housing including an upper end having therein entry and exit passages to permit liquid to enter said housing, pass through said filtering media, and thereafter exit said housing; (ii) a threaded portion to releasably engage a correspondingly threaded portion of the filter head assembly such that said filter cartridge may be threadably received on or secured to the filter head assembly through rotational engagement of said respective threaded portions, wherein rotational engagement of said filter cartridge with the filter head assembly permits liquid to pass from the filter head assembly to said entry passage and permits liquid to pass from said exit passage into said filter head assembly; (iii) one or more rotationally engagable locks that secure said filter cartridge to the filter head assembly upon the threaded engagement of said filter cartridge with said filter head assembly, said rotationally engagable locks helping to resist the rotational disengagement of said filter cartridge from the filter head assembly; and, (iv) a frangible member sealing said entry passage to help prevent the ingress of debris or contaminates into said housing, said frangible member ruptured upon the rotational engagement of said filter cartridge with the filter head assembly.

In a further aspect the invention provides A filter cartridge for use with a filter head assembly, the filter cartridge comprising (i) a housing enclosing a filtering media and including entry and exit passages to permit fluid to enter said housing, pass through said filtering media, and thereafter exit said housing through said exit passage; (ii) a retainer releasably securable to a receiver in the filter head assembly such that rotational engagement of said filter cartridge with the filter head assembly causes said retainer and receiver to releasably secure said filter cartridge to the filter head assembly and to thereby permit fluid to travel from the filter head assembly to said entry passage of said housing and to permit fluid to pass from said exit passage of said housing into the filter head assembly; and, one or more flexibly resilient locking tabs, said locking tabs having a rest position and a displaced position and being biased toward said rest position, upon rotational engagement of said filter cartridge with the filter head assembly said one or more locking tabs engaging one or more locking tab actuators on the filter head assembly thereby deflecting said locking tabs from their rest to their displaced position to assist in preventing the rotational disengagement of said filter cartridge from the filter head assembly.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a side perspective view of a filter cartridge or canister constructed in accordance with one of the preferred embodiments of the present invention shown attached to a filter head assembly;

FIG. 2 is a side perspective view of a dual filter cartridge or canister assembly constructed in accordance with one of the preferred embodiments of the present invention;

FIG. 3 is a side perspective view of the filter cartridge and filter head assembly shown in FIG. 1, wherein the cartridge has been removed from the filter head assembly;

FIG. 4 is an upper side perspective view of the top of a filter cartridge or canister constructed in accordance with one of the preferred embodiments of the present invention;

FIG. 5 is top view of the filter cartridge or canister shown in FIG. 7;

FIG. 6 is a bottom view of the filter head assembly shown in 3;

FIG. 7 is a cross-sectional detail view of the locking tabs and locking tab actuators of the filter cartridge and filter head assembly prior to full engagement.

FIG. 8 is a cross-sectional detail view of the locking, tabs and locking tab actuators of the filter cartridge and filter head assembly at full engagement.

FIG. 9 is a sectional view taken along the lines 9-9 in FIG. 1;

FIG. 10 is a sectional view taken along the lines 10-10 in FIG. 1;

FIG. 11 is an exploded view of the cross sectional view shown in FIG. 10 with the cover of the filter head assembly removed.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

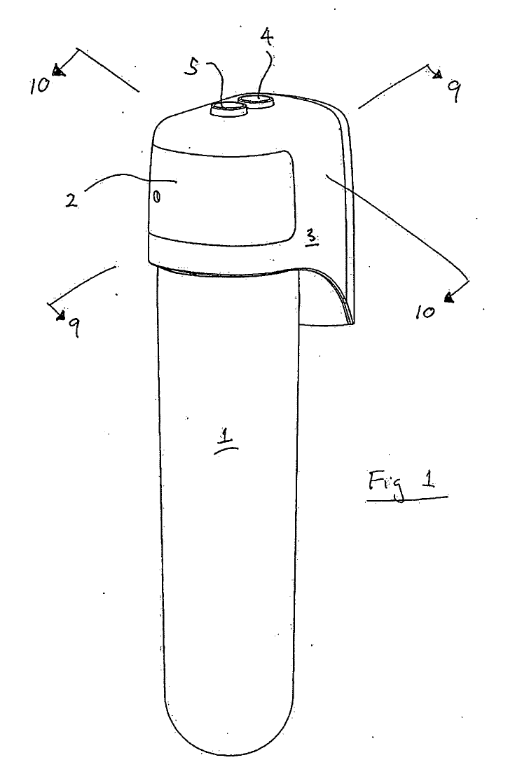

A filter cartridge assembly constructed in accordance with one of the preferred embodiments of the present invention is shown in the accompanying drawings and identified generally by reference numeral 1. In FIG. 1, filter cartridge assembly 1 is shown as it would typically be used in association with a filter head assembly 2 for purposes of filtering a stream of pressurized fluid. Filter head assembly 2 may take any one of a wide variety of different shapes and configurations. In most instances the filter head assembly will be comprised of an assembly housing 3 that contains some form of manifold comprising a series of internal passageways to direct unfiltered water or fluid into filter cartridge 1 with clean or filtered water or fluid discharged through an outlet port. In FIG. 1 filter head assembly 2 is shown as having an inlet port 4 and an outlet port 5 that permit the assembly to be readily integrated into a residential or commercial water system. In this manner unfiltered or untreated water will enter the filter head assembly through inlet port 4 and be directed into filter cartridge 1 where internal filter media within the cartridge will remove particular forms of contaminates. Thereafter the filtered or cleaned water will exit the filter cartridge, enter the filter head assembly and then re-enter the residential or commercial water system through outlet port 4.

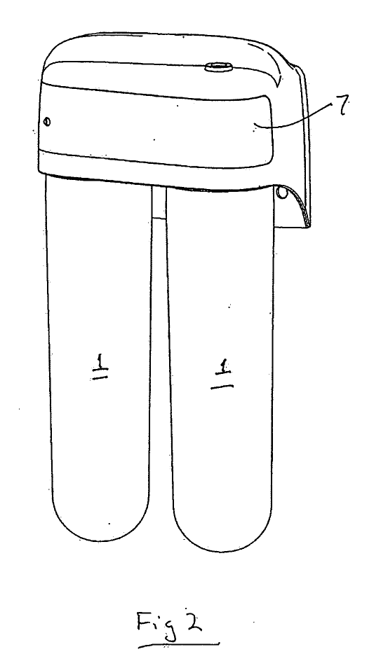

Typically filter cartridge assembly 1 will be comprised of a housing 6 that in most instances will take the form of a generally cylindrical shaped enclosed pressure vessel or canister. Housing 6 encloses a filter media (not shown) that may be one of any wide variety of commonly used filter media, depending on the particular contaminates of concern. As shown in FIG. 2, in some instances it may be desirable to utilize a dual filter head assembly 7 having the capacity to receive two filter cartridges that are effectively connected together in the series such that the second cartridge offers an enhanced degree of filtration.

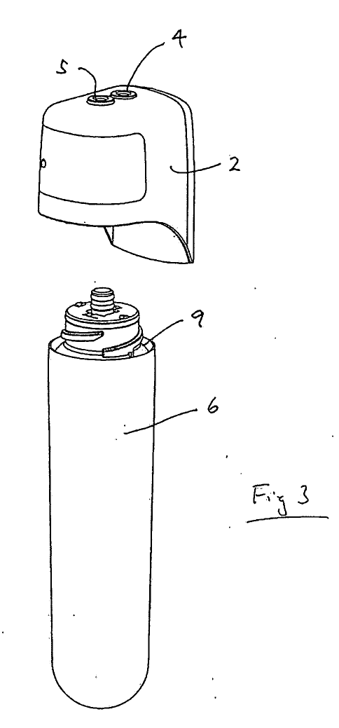

Regardless of whether a single, dual or other multi-filter cartridge assembly is utilized, for ease of operation filter cartridge 1 is preferably designed so that it can be attached and/or removed from the filter head assembly with relative ease and without the use of tools. With reference to FIGS. 3 through 6, it will be appreciated that in a preferred embodiment of the invention housing 6 will be formed having an enclosed lower end creating an internal cavity in which the filter media 8 may be received. An upper end 9 can be attached to housing 6 to effectively seal the canister and retain the filter media in place. It will be appreciated that wide variety of mechanisms may be utilized to seal the upper end to housing 6, including, but not limited to, threading the parts together, the use of glues and adhesives, spin welding, and other mechanical fastening methods. In any event, once fully assembled housing 6 will securely retain filter media 8 therein while permitting the flow of liquid into and out of the interior of the housing through the use of entry and exit passages, 10 and 11 respectively, in the housing's upper end. That is, entry passage 10 will permit liquid to enter the interior portion of housing 6, to pass through filter media 8, and to eventually be discharged through exit passage 11 and into outlet port 5 of filter head assembly 2. In the embodiment of the invention shown in the attached drawings, entry passage 10 is comprised of one or more openings or passageways in the upper end 9 of housing 6. Similarly, in the attached drawings exit passage 11 is shown as comprising a generally circular and centrally located hole or passageway positioned on the upper end of housing 6. It will, of course, be appreciated by those skilled in the art having an understanding of the invention that a variety of different locations and geometric configurations for the entry and exit passageways could equally be used while remaining within the broad scope of the invention.

In order for filter cartridge 1 to perform its intended function it will be necessary for the filter cartridge to engage the filter head assembly so that fluid can flow between the filter cartridge or canister and the head assembly. Preferably filter cartridge 1 includes a retainer to releasably engage a receiver in the filter head assembly upon the rotational engagement of filter cartridge 1 with filter head assembly 2. In a preferred embodiment of the invention rotational engagement of the filter cartridge with the head assembly causes retainer 12 and receiver 13 to releasably secure the filter cartridge to the filter head assembly. In this manner unfiltered fluid is permitted to travel from the filter head assembly into the housing of the filter cartridge where it can be exposed to the filtering media and thereafter returned to the filter head assembly via exit passage 11. Once again, it will be appreciated by those skilled in the art that retainer 12 and receiver 13 could be comprised of a variety of different mechanical structures, however, in most instances (including that as shown in the attached drawings), it is expected that retainer 12 and receiver 13 will comprise complimentary threaded portions to permit filter cartridge 1 to be threadably secured to the filter head assembly. In an alternate embodiment retainer 12 and receiver 13 could be complementary lugged portions having angled or cammed surfaces that allow for rotational engagement.

In accordance with one embodiment of the invention there is also provided one or more rotationally engagable locks 14 used to secure the filter cartridge to the filter head assembly upon their rotational engagement. As will become clear from an appreciation of the structure and function of the rotationally engagable locks, they serve the purpose of helping to resist the rotational disengagement of the filter cartridge from the filter head assembly. During use of the cartridge and filter head assembly the effects of pressure and water hammer can sometimes result in a backing off or unthreading of the cartridge from the head assembly, potentially causing leaks and/or contamination. Through the incorporation of rotationally engagable locks the present invention provides a means to help resist such rotational disengagement.

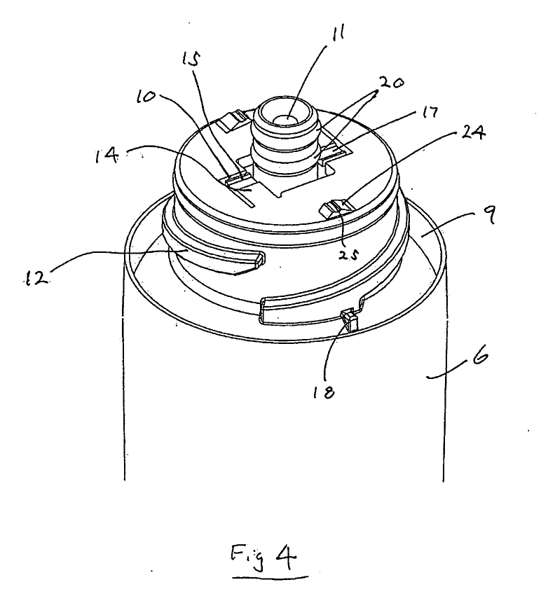

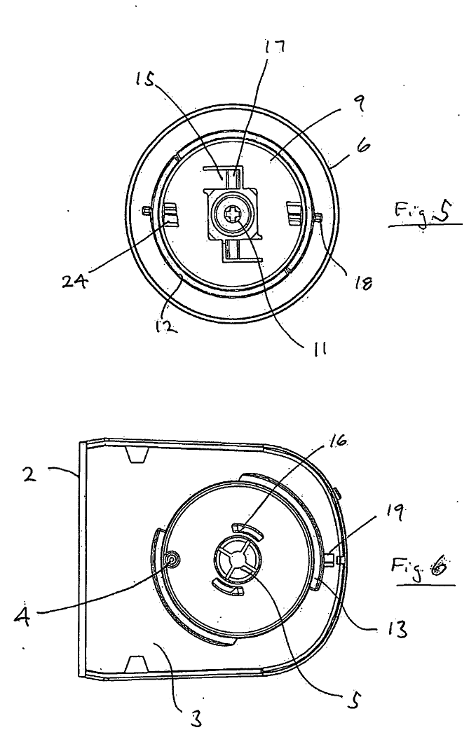

Looking specifically at FIGS. 4 and 5, in the embodiment depicted therein rotationally engagable locks 14 comprise one or more flexibly resilient locking tabs 15 situated on the upper end 9 of housing 6. Locking tabs 15 have a rest position where they are generally aligned with upper surface of upper end 9 of housing 6 (see FIG. 4), and a displaced position where they are deflected or displaced downwardly into the interior of housing 6. The resiliency of the locking tabs causes them to be biased toward their rest position.

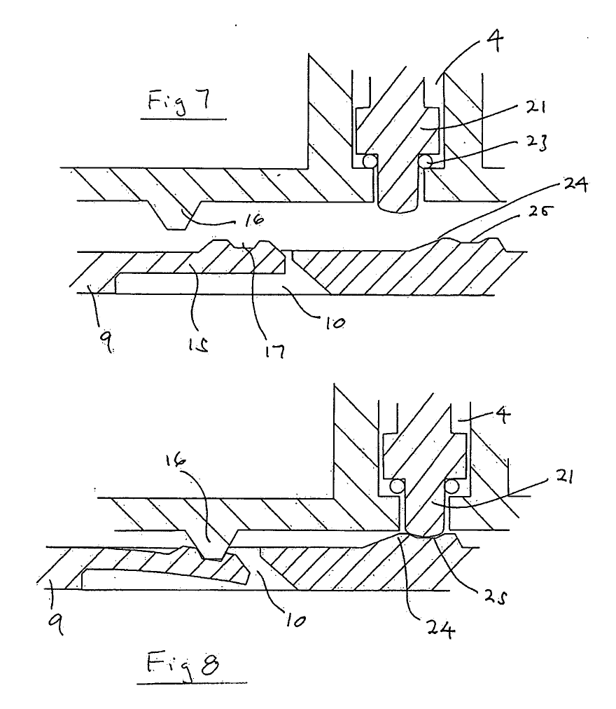

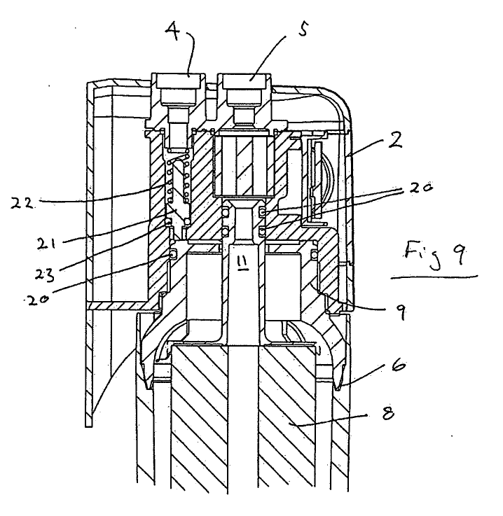

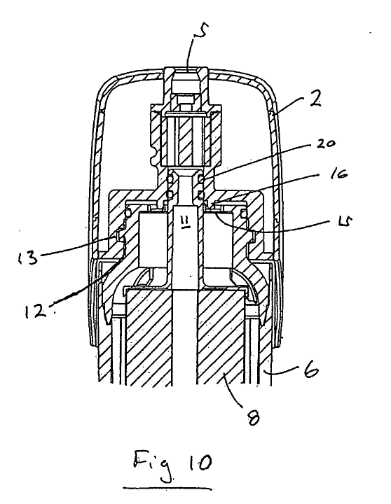

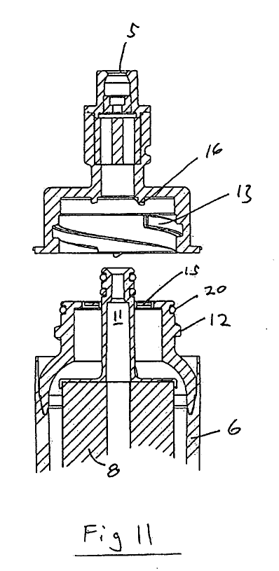

In accordance with the invention, upon the rotational engagement of the filter cartridge with the filter head assembly the one or more locking tabs 15 engage one or more locking tab actuators 16 on the filter head assembly to cause the locking tabs to deflect from their rest to their displaced position. FIGS. 7 and 8 are enlarged fragmentary views of the upper end of housing 6 and the interior portion of filter head assembly 2 against which the housing is engaged. FIG. 7 shows the relative position of locking tabs 15 and locking tab actuators 16 immediately prior to full engagement of the filter cartridge with the filter head assembly. In FIG. 8 the cartridge and head assembly are fully engaged with the locking tab actuators deflecting the locking tabs downwardly into housing 6 and into their displaced position.

As is also shown in FIGS. 7 and 8, locking tabs 15 may be formed with indentations or detents 17 on their upper surfaces. The detents are preferably of a size and dimension that generally corresponds to the size and configuration of the lower ends of locking tab actuators 16. As such, when the locking tab actuators are engaged with the locking tabs the lower surface of the actuators will be received within detents 17. The biasing force of the displaced locking tabs helps to retain the actuators within detents 17 and helps prevent unintentional rotational disengagement of the filter cartridge from the filter head assembly. This interaction between locking tabs 15 and locking tab actuators 16 has the effect of requiring the application of a discrete rotational force to housing 6 in order to dislodge the actuators from the detents and to permit the disengagement of the filter cartridge. The chances of accidental or unintentional dislodging of the filter cartridge from the filter head assembly is thereby significantly reduced, or in many cases eliminated.

It will also be apparent from an examination of the structure shown in the attached drawings, and in particular FIGS. 7 and 8, that in one of the preferred embodiments of the invention the surfaces of locking tab actuators 16 and detents 17 may be angled or sloped. Sloping those surfaces facilitates the entry of the actuators into the detents, and also assists in the deflection of the locking tabs downwardly into housing 6. Forming detents 17 and actuators 16 with sloped and correspondingly shaped outer surfaces will also tend to effectively create a “snap fit” that will enhance their engagement and more securely hold the filter cartridge within the filter head assembly.

It will be appreciated that alternate forms or types of locking tabs 15 and lock tab actuators 16 could be utilized while remaining within the broad scope of the invention. For example, the relative positions of the locking tabs and actuators on the filter cartridge and filter head assembly could be reversed with the locking tabs positioned on the head assembly and the actuators located on the upper end of the cartridge. Further, rather than forming the locking tabs in a fashion that allows them to be displaced downwardly into the housing of the filter cartridge, the locking tabs could be in the form of a ramped surface having detents that are engaged by a spring actuated or biased locking tab actuator. That is, as opposed to the structure shown in the attached drawings wherein the tabs are displaced and the tab actuators are fixed, in an alternate embodiment of the invention the tabs could be fixed in position with the tab actuators being displaceable. Other forms configurations of locking mechanisms will also be apparent to those of skill in the art.

Housing 6 of filter cartridge 1 may also include a rotational stop 18 that is received against a shoulder 19 within filter head assembly 2 when the filter cartridge is fully engaged with the filter head assembly. In the embodiment of the invention shown in the attached drawings when the filter cartridge is fully inserted into the filter head stop 18 will abut against shoulder 19 to prevent further rotational engagement of the cartridge within the head assembly. In this manner, the degree of engagement of the filter cartridge within the head assembly can be pre-determined in order to ensure that when the cartridge is fully engaged within the head assembly locking tabs 15 are in alignment with locking tab actuators 16 so that the actuators can be received within detents 17. Rotational stop 18 and shoulder 19 will also prevent over tightening of the filter cartridge within the head assembly and will help to prevent potential damage to one or both of the two components. Similarly, utilization of stop 18 and shoulder 19 will provide a mechanism by which a user will know when the cartridge has been threaded into the head assembly to the point that the two components are sufficiently secured together so that O-rings or seals 20 prevent leakage between internal and/or external parts.

While it will be understood that locking tabs 15 could be positioned at a variety of different locations about the upper end 9 of housing 6 while performing their described function, in one of the preferred embodiments of the invention the locking tabs are located within entry passage 10. It will thus be appreciated (see FIGS. 4 and 5) that when the locking tabs are deflected from their rest to their displaced position, there will be a resulting increase in the effective or useful size of the opening in entry passage 10. Such a structure presents the ability for a manufacturer to design locking tabs and an entry passage of a 'size that permits a pre-determined flow of fluid through filter cartridge 1. Depending upon the particular application at hand, there may be a desire to regulate or limit then amount of fluid flow through the cartridge and the filtering media. It will thus be appreciated that altering the physical dimensions of the locking tabs and/or the size of the entry passage permits the manufacturer to simply and cost effectively ensure a maximum flow through the cartridge for a given pressure range. In addition, different filter cartridges or canisters permitting different flow rates can be designed for use on the same filter head assembly by merely altering the size of the locking tabs on the cartridge without having to modify or alter the filter head assembly.

The described structure of the present invention further permits entry passage 10 to be sealed with a frangible member to prevent the ingress of debris or contaminates into the interior of housing 6. It is expected that in most instances the frangible member would be comprised of a paper or similar type seal that is ruptured upon the engagement of the filter cartridge with the filter head assembly to permit the flow of fluid into the cartridge. In the embodiment of the invention where locking tabs 15 are situated within entry passage 10, the deflection of the locking tabs from their rest to their displaced position through engagement with locking tab actuators 16 will result in a rupturing of the frangible member. It will thus be appreciated that such a structure will effectively seal off entry passage 10 thereby preventing dirt and debris from getting into the interior of housing 6 prior to the engagement of the housing with the filter head assembly. At the same time, the structure presents a simple and effective manner to rupture the frangible member and in effect “open” the entry passage upon the engagement of the filter cartridge with the filter head assembly.

The filter cartridge and filter head assembly described herein may also be fitted with an automatic valve structure that opens and closes the inlet port in head 2 as required in order to permit fluid to flow into filter cartridge or canister 1. The vale will also prevent the flow of fluid and leakage through inlet port 4 when filter cartridge 1 has been removed. In the particular embodiment depicted in the attached drawings, the valve is comprised of a spring actuated pin 21 situated within the fluid passageway connected to inlet port 4 and filter head assembly 2. Pin 21 is biased through the action of a spring 22 to a closed position where it seals off the fluid passageway preventing fluid from leaking from the filter head assembly until such time as force is applied to the pin to overcome the biasing effect of the spring. To enhance the sealing effect of pin 21, an oaring or seal 23 may be positioned between the sealing surface of the pin and the internal portion of the filter head upon which it seats.

In order to permit the valve to be opened when filter cartridge or canister 1 is received within the filter head assembly, in the preferred embodiment the upper end 9 of housing 6 is fitted with a lug 24 which preferably has a sloped or cammed upper surface that contacts the lower portion of pin 21 when the filter cartridge is fully engaged within the head assembly. The upper surface of lug 24 may further include a small detent 25 (see FIG. 7) into which the lower end of pin 21 may be received. It will also be appreciated from a complete understanding of the invention that the interaction of rotational stop 18 with shoulder 19 when the filter cartridge is fully engaged within the filter head assembly will not only ensure that locking tab actuators 16 are in alignment with locking tabs 15, but will also ensure that lug 24 is in proper alignment with pin 21 in order to effectively open (and hold open) the valve in the internal passageway leading to inlet port 4. In this manner, the full engagement of the filter cartridge within the head assembly will ensure both the locking of the cartridge to the head assembly and the opening of a valve to permit fluid to flow into the filter canister.

It is to be understood that what have been described are the preferred embodiments of the invention and that it may be possible to make variations to these embodiments while staying within the broad scope of the invention. Some of these variations have been discussed while others will be readily apparent to those skilled in the art.

I claim:

1. A filter cartridge for use with a filter head assembly and for filtering a stream of pressurized fluid, the filter cartridge comprising:
(i) a housing enclosing filtering media, said housing including an upper end having therein entry and exit passages to permit fluid to enter said housing, pass through said filtering media, and exit said housing
(ii) a retainer to releasably engage a receiver in a filter head assembly such that rotational engagement of said filter cartridge with the filter head assembly causes said retainer and said the receiver to releasably secure said filter cartridge to the filter head assembly and to thereby permit fluid to travel from the filter head assembly through said entry passage and to permit fluid to pass from said exit passage into the filter head assembly; and,
(iii) one or more rotationally engagable locks securing said filter cartridge to the filter head assembly upon the rotational engagement of said filter cartridge with the filter head assembly, said locks helping to resist the rotational disengagement of said filter cartridge from the filter head assembly.

2. The filter cartridge as claimed in claim 1 wherein said retainer on said filter cartridge and the receiver in the filter head assembly comprise complimentary threaded portions to permit said filter cartridge to be threadably secured to the filter head assembly.

3. The filter cartridge as claimed in claim 1 wherein said rotationally engagable locks comprise one or more flexibly resilient locking tabs that engage one or more locking tab actuators upon the rotational engagement of said filter cartridge with the filter head assembly.

4. The filter cartridge as claimed in claim 3 wherein said locking tabs have a rest position and a displaced position and are biased toward said rest positions upon rotational engagement of said filter cartridge with the filter head assembly said one or more locking tabs engaging said locking tab actuators thereby deflecting said locking tabs from their rest to their displaced position.

5. The filter cartridge as claimed in claim 1 wherein said housing includes a rotational stop, said rotational stop received against a shoulder within the filter head assembly upon the rotational engagement of said filter cartridge with the filter head assembly to thereby prevent the rotational engagement of said filter cartridge with said filter head assembly beyond a predetermined limit.

6. The filter cartridge as claimed in claim 4 wherein said housing includes a rotational stop, said rotational stop received against a shoulder within the filter head assembly upon the engagement of said filter cartridge with the filter head assembly thereby preventing the rotational engagement of said filter cartridge within the filter head assembly beyond a predetermined limit.

7. The filter cartridge as claimed in claim 6 wherein said one or more locking tabs are fully engaged with said one or more locking tab actuators upon the receipt of said rotational stop against said shoulder.

8. The filter cartridge as claimed in claim 4 wherein said locking tabs are positioned in said entry passage in said upper end of said housing such that the deflection of said locking tabs from said rest to said displaced position results in an increase in the size of the opening in said entry passage.

9. The filter cartridge as claimed in claim 1 wherein said entry passage is sealed with a frangible member to help prevent the ingress of debris or contaminants into said housing prior to the engagement of said filter cartridge with the filter head assembly.

10. The filter cartridge as claimed in claim 9 wherein said frangible member is ruptured upon the engagement of said filter cartridge with the filter head assembly.

11. A filter cartridge for use with a filter head assembly and for filtering a stream of pressurized fluid, the filter cartridge comprising.
(i) a housing enclosing a filtering media, said housing including an upper end having therein entry and exit passages to permit liquid to enter said housing, pass through said filtering media, and thereafter exit said housing;
(ii) a threaded portion to releasably engage a correspondingly threaded portion of the filter head assembly such that said filter cartridge may be threadably received on or secured to the filter head assembly through rotational engagement of said respective threaded portions, wherein rotational engagement of said filter cartridge with the filter head assembly permits liquid to pass from the filter head assembly to said entry passage and permits liquid to pass from said exit passage into said filter head assembly;
(iii) one or more rotationally engagable locks that secure said filter cartridge to the filter head assembly upon the threaded engagement of said filter cartridge with said filter head assembly, said rotationally engagable locks helping to resist the rotational disengagement of said filter cartridge from the filter head assembly; and,
(iv) a frangible member sealing said entry passage to help prevent the ingress of debris or contaminates into said housing, said frangible member ruptured upon the rotational engagement of said filter cartridge with the filter head assembly.

12. A filter cartridge for use with a filter head assembly, the filter cartridge comprising:
(i) a housing enclosing a filtering media and including entry and exit passages to permit fluid to enter said housing, pass through said filtering media, and thereafter exit said housing through said exit passage;
(ii) a retainer releasably securable to a receiver in the filter head assembly such that rotational engagement of said filter cartridge with the filter head assembly causes said retainer and receiver to releasably secure said filter cartridge to the filter head assembly and to thereby permit fluid to travel from the filter head assembly to said entry passage of said housing and to permit fluid to pass from said exit passage of said housing into the filter head assembly; and,
(iii) one or more flexibly resilient locking tabs, said locking tabs having a rest position and a displaced position and being biased toward said rest position, upon rotational engagement of said filter cartridge with the filter head assembly said one or more locking tabs engaging one or more locking tab actuators on the filter head assembly thereby deflecting said locking tabs from their rest to their displaced position to assist in preventing the rotational disengagement of said filter cartridge from the filter head assembly.

13. The filter cartridge as claimed in claim 12 wherein said entry passage is sealed with a frangible member to help prevent the ingress of debris or contaminates into said housing prior to said filter cartridge becoming releasably secured to the filter head assembly.

14. The filter cartridge as claimed in claim 13 wherein said locking tabs are positioned in said entry passage of said housing such that the deflection of said locking tabs from said rest to said displaced position causes a rupture of said frangible member permitting liquid to flow from the filter head assembly through said entry passage and into said housing.

15. The filter cartridge as claimed in claim 12 wherein said housing includes a rotational stop, said rotational stop received against a shoulder of the filter head assembly upon full rotational engagement of said filter cartridge with the filter head assembly.

16. The filter cartridge as claimed in claim 15 wherein said one or more locking tabs are fully engaged with said one or more locking tab actuators upon the receipt of said rotational stop against the shoulder of the filter head assembly.

17. The filter cartridge as claimed in claim 16 wherein said entry passage is sealed with a frangible member to help prevent the ingress of debris or contaminants into said housing prior to said filter cartridge becoming releasably secured to the fitter head assembly.
